(19) United States
(12) Patent Application Publication
(10) Pub. No.: US 2011/0164674 A1
(43) Pub. Date: Jul. 7, 2011

(54) MULTIMEDIA COMMUNICATION SYSTEM, AND TELEVISION DEVICE AND CORE MODULE THEREOF

(75) Inventors: CHIH-YUAN HOU, TAIPEI HSIEN (TW); TSAO-TENG TSENG, TAIPEI HSIEN (TW); CHI-WEN CHEN, TAIPEI HSIEN (TW)

(73) Assignee: LITE-ON TECHNOLOGY CORP., TAIPEI (TW)

(21) Appl. No.: 12/983,456

(22) Filed: Jan. 3, 2011

(30) Foreign Application Priority Data
Jan. 5, 2010 (TW) 099100089

(51) Int. Cl. G10L 19/00; H04N 7/26; H04W 88/02

(52) U.S. Cl. 375/240.01; 704/500; 704/E19.001; 375/E07.026

(57) ABSTRACT

A multimedia communication system includes: an intercom device operable for picking up audio information, and for performing encoding and modulation processes upon the audio information so as to generate a modulated signal; and a multimedia device coupled to the intercom device for receiving the modulated signal therefrom, and operable for performing demodulation and decoding processes upon the modulated signal so as to generate a decoded audio signal, for generating an output audio signal from external audio information contained in an external input signal when the decoded audio signal is not received thereby, for generating the output audio signal from at least the decoded audio signal when the decoded audio signal and the external input signal are received thereby, and for audible reproduction of the output audio signal.

### CROSS-REFERENCE TO RELATED APPLICATION

This application claims priority of Taiwanese Application No. 099100089, filed on Jan. 5, 2010.

### BACKGROUND OF THE INVENTION

1. Field of the Invention

The present invention relates to a communication system, more particularly to a multimedia communication system, and a television device and a core module thereof.

2. Description of the Related Art

A door intercom device is generally installed at an entrance to a residence so as to enable remote communication between visitors near the door intercom device and people inside the residence.

However, upon activation of a correspondent intercom device by the visitors via the door intercom device, a person inside the residence may have to stop on-going activities or even move toward the correspondent intercom device so as to initiate communication with the visitors via the correspondent intercom device and the door intercom device, which may be disturbing especially when watching a television program.

### SUMMARY OF THE INVENTION

Therefore, an object of the present invention is to provide a multimedia communication system capable of alleviating the aforesaid drawbacks of the prior art.

Accordingly, a multimedia communication system of the present invention is adapted to receive an external input signal that contains external audio information, and includes an intercom device and a multimedia device.

The intercom device includes: a first sound-pickup module operable for picking up first audio information so as to generate a first to-be-encoded audio signal; a first signal processing module operable for performing an encoding process upon the first to-be-encoded audio signal so as to generate a first to-be-transmitted signal; and a first communication module operable for performing a modulation process upon the first to-be-transmitted signal so as to generate a first modulated signal.

The multimedia device includes: a second communication module coupled to the first communication module for receiving the first modulated signal therefrom, and operable for performing a demodulation process upon the first modulated signal so as to generate a first to-be-decoded signal; a second signal processing module operable for performing a decoding process upon the first to-be-decoded signal so as to generate a first decoded audio signal; a core module adapted to receive the external input signal, and operable to generate a first output audio signal from at least one of the first decoded audio signal and the external audio information ion contained in the external input signal; and a second audio reproduction module operable for audible reproduction of the first output audio signal.

The core module is operable for generating the first output audio signal from the external audio information contained in the external input signal when the first decoded audio signal is not received thereby. The core module is operable for generating the first output audio signal from at least the first decoded audio signal when the first decoded audio signal and the external input signal are received thereby.

Preferably, the external input signal further contains external video information. The intercom device further includes a video-capture module operable for capturing video information so as to generate a to-be-encoded video signal. The first signal processing module is operable for performing the encoding process upon the first to-be-encoded audio signal and the to-be-encoded video signal so as to generate the first to-be-transmitted signal. The second signal processing module is operable for performing the decoding process upon the first to-be-decoded signal so as to generate the first decoded audio signal and a decoded video signal. The core module is further operable to generate an output video signal from at least one of the decoded video signal and the external video information contained in the external input signal. The multimedia device further includes a display module operable for display of the output video signal. The core module is operable for generating the output video signal from the external video information contained in the external input signal when the decoded video signal is not received thereby. The core module is operable for generating the output video signal from at least the decoded video signal when the decoded video signal and the external input signal are received thereby.

Another object of the present invention is to provide a television device capable of alleviating the aforesaid drawbacks of the prior art.

Accordingly, a television device is adapted to receive a first modulated signal that contains first audio information picked up by an intercom device, and an external input signal that contains external audio information. The television device includes: a communication module adapted for receiving the first modulated signal, and operable for performing a demodulation process upon the first modulated signal so as to generate a to-be-decoded signal; a signal processing module operable for performing a decoding process upon the to-be-decoded signal so as to generate a decoded audio signal; a core module adapted to receive the external input signal, and operable to generate an output audio signal from at least one of the decoded audio signal and the external audio information contained in the external input signal; and an audio reproduction module operable for audible reproduction of the output audio signal.

The core module is operable for generating the output audio signal from the external audio information contained in the external input signal when the decoded audio signal is not received thereby. The core module is operable for generating the output audio signal from at least the decoded audio signal when the decoded audio signal and the external input signal are received thereby.

Preferably, the first modulated signal further contains first video information captured by the intercom device, the external input signal further containing external video information. The signal processing module is operable for performing the decoding process upon the to-be-decoded signal so as to generate the decoded audio signal and a decoded video signal. The core module is further operable to generate an output video signal from at least one of the decoded video signal and the external video information contained in the external input signal. The television device further includes a display module operable or display of the output video signal. The core module is operable for generating the output video signal from the external video information contained in the external input signal when the decoded video signal is not received thereby. The core module is operable for generating the output video signal from at least the decoded video signal when the decoded video signal and the external input signal are received thereby.

Yet another object of the present invention is to provide a core module for a television device.

Accordingly, a core module of the present invention is adapted to receive a decoded audio signal and an external input signal containing external audio information, and is operable for generating an output audio signal from at least one of the decoded audio signal and the audio information contained in the external input signal for sound reproduction.

The core module includes: a tuning unit adapted to receive the external input signal, and operable for performing a frequency tuning process upon the external input signal so as to generate an input audio signal; and an audio processing unit operable for generating the output audio signal from the input audio signal when the decoded audio signal is not received by the core module, and from at least the decoded audio signal when the decoded audio signal and the external input signal are received by the core module.

Preferably, the external input signal further contains external video information. The core module further includes a video processing unit, is further adapted to receive a decoded video signal, and is further least one of the decoded video signal and the video information contained in the external input signal for visual rendering. The tuning unit is operable for performing the frequency tuning process upon the external input signal so as to generate the input audio signal and an input video signal. The video processing unit is operable for generating the output video signal from the input video signal when the decoded video signal is not received by the core module, and from at least the decoded video signal when the decoded video signal and the external input signal are received by the core module.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of the preferred embodiment of a multimedia communication system according to the present invention;

FIG. 2 is a block diagram of an intercom device of the multimedia communication system of the preferred embodiment;

FIG. 3 is a block diagram of a multimedia device of the multimedia communication system of the preferred embodiment;

FIG. 4 is a block diagram of a modification of the multimedia device according to the present invention;

FIG. 5 is a block diagram of a core module of the multimedia device; and

FIG. 6 is a block diagram of a modification of the core module according to the present invention.

### DETAILED DESCRIPTION OF THE PREFERRED EMBODIMENT

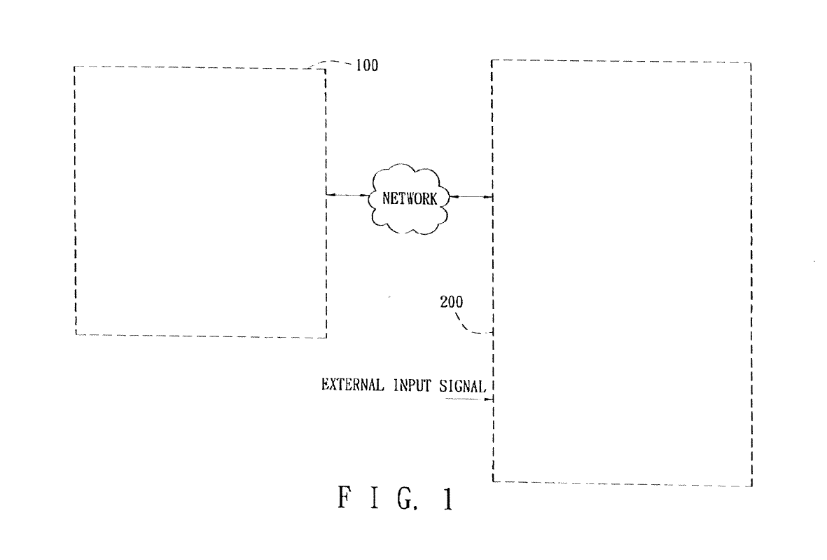

Referring to FIG. 1, the preferred embodiment of a multimedia communication system of the present invention includes an intercom device 100 and a multimedia device 200, which, in the present embodiment, is exemplified as a television device. The intercom device 100 and the multimedia device 200 are connected to each other via a network to enable audio and video communication between visitors and people inside a residence.

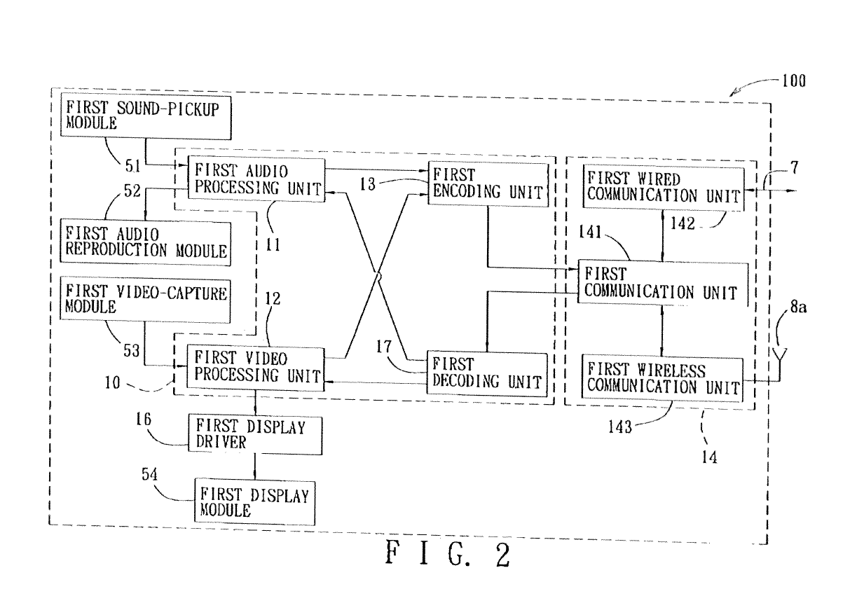

With further reference to FIG. 2, the intercom device 100 of the preferred embodiment includes: a first sound-pickup module 51 (e.g., a microphone module) operable for picking up first audio information (e.g., voices of the visitors) so as to generate a first to-be-encoded audio signal; a first video-capture module 53 operable for capturing first video information (e.g., images of the visitors) so as to generate a first to-be-encoded video signal; a first signal processing module 10 operable for performing an encoding process upon the first to-be-encoded audio signal and the first to-be-encoded video signal so as to generate a first to-be-transmitted signal; and a first communication module 14 operable for performing such as a modulation process upon the first to-be-transmitted signal so as to generate a first modulated signal.

In the present embodiment, the first signal processing module 10 includes: a first audio processing unit 11 operable for processing the first to-be-encoded audio signal so as to generate a first intermediate encoded audio signal; a first video processing unit 12 operable for processing the first to-be-encoded video signal so as to generate a first intermediate encoded video signal; and a first encoding unit 13 operable for performing preferably a Moving Picture Experts Group (MPEG) encoding process upon the first intermediate encoded audio signal and the first intermediate encoded video signal so as to generate the first to-be-transmitted signal.

In the present embodiment, the first communication module 14 includes a first communication unit 141, first wired communication unit 142, and a first wireless communication unit 143. The first communication unit 141 is operable for performing such as the modulation process upon the first to-be-transmitted signal so as to generate the first modulated signal, and for initiating a communication session with the multimedia device 200 through a selected one of the first wired communication unit 142 and the first wireless communication unit 143 based on a combination of Session Initiating Protocol (SIP) techniques and transmission control protocol internet protocol (TCP/IP) suite so as to enable transmission of the first modulated signal therethrough. The first wired communication unit 142 is preferably an ethernet communication unit connected to the multimedia device 200 via an ethernet cable 7, and the first wireless communication unit 143 is preferably a worldwide interoperability for microwave access (WIMAX) communication unit coupled to the multimedia device 200 via a first antenna 8a.

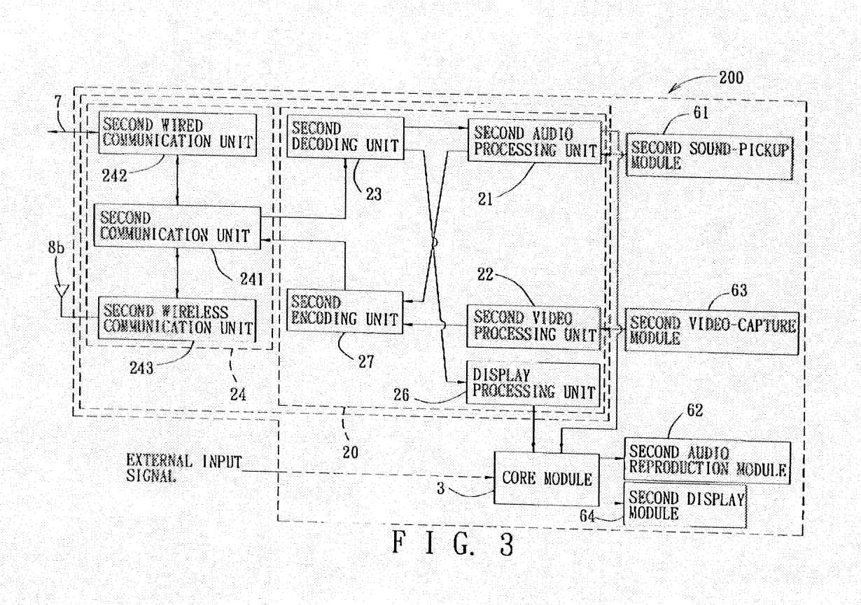

With further reference to FIG. 3, the multimedia device 200 includes: a second communication module 24 coupled to the first communication module 14 for receiving the first modulated signal, and operable for performing such as a demodulation process upon the first modulated signal so as to generate a first to-be-decoded signal; a second signal processing module 20 operable for performing a decoding process upon the first to-be-decoded signal so as to generate a first decoded audio signal and a first decoded video signal; a core module 3 adapted to receive an external input signal containing external audio and video information, operable to generate a first output audio signal from at least one of the first decoded audio signal and the external audio information, and operable to generate a first output video signal from at least one of the first decoded video signal and the external video information; a second audio reproduction module 62 operable for audible reproduction of the first output audio signal; and a second display module 64 operable display of the first output video signal.

In the present embodiment, the second communication module 24 includes a second communication unit 241, a second wired communication unit 242, and a second wireless communication unit 243. The second communication unit 241 is operable for establishing the communication session with the intercom device 100 through one of the second wired communication unit 242 and the second wireless communication 243 using the combination of SIP techniques and TCP/IP suite so as to enable receipt of the first modulated signal therethrough, and for performing such as the demodulation process upon the first modulated signal so as to generate the first to-be-decoded signal. The second wired communication unit 242 is preferably an ethernet communication unit connected to the first wired communication unit 142 via the ethernet cable 7, and the second wireless communication unit 243 is preferably a WIMAX communication unit coupled to the first wireless communication unit 143 via a second antenna 8b.

In the present embodiment, the second signal processing module 20 includes: a second decoding unit 23 operable for performing preferably an MPEG decoding process upon the first to-be-decoded signal so as to generate a first intermediate decoded audio signal and a first intermediate decoded video signal; a second audio processing unit 21 operable for processing the first intermediate decoded audio signal so as to generate the first decoded audio signal; and a display processing unit 26 operable for processing the first intermediate decoded video signal so as to generate the first decoded video signal.

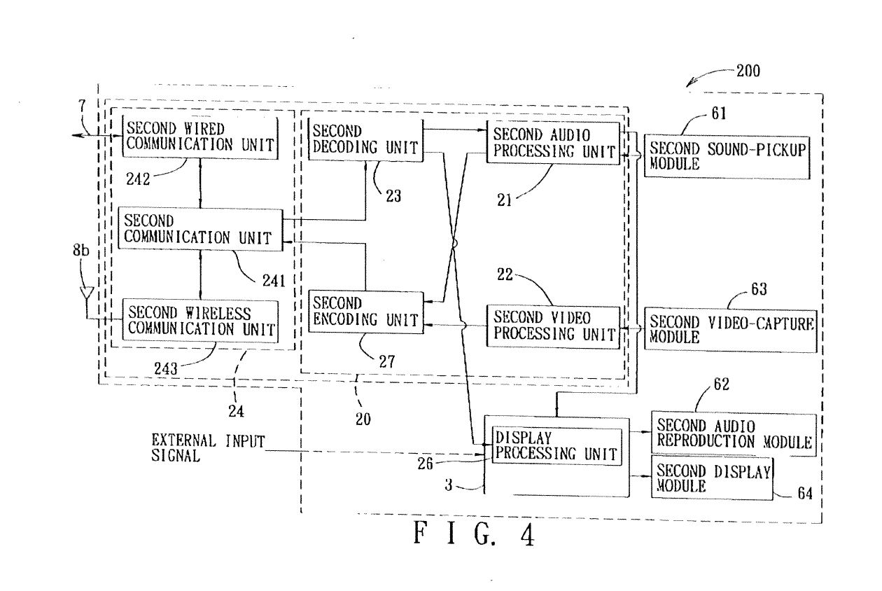

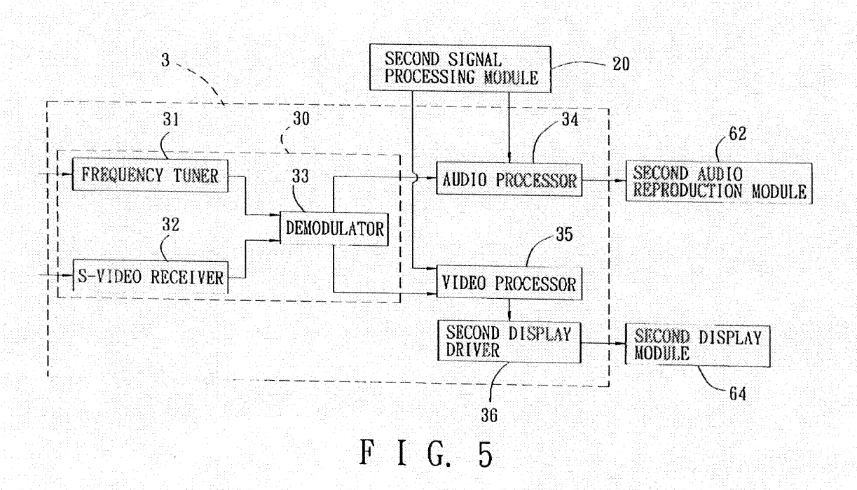

Although the display processing unit 26 of the preferred embodiment is implemented in the second signal processing module 20, it may be implemented in the core module 3 in a modification of the preferred embodiment (see FIG. 4). With further reference to FIG. 5, the external input signal received by the core module 3 may include, but is not limited to, a television signal, an audio-video signal, an HDMI signal, and an S-video signal. The core module 3 of the preferred embodiment includes a demodulating unit 30, an audio processor 34, a video processor 35, and a second display driver 36.

The demodulating unit 30 is preferably a tuning unit including: a frequency tuner 31 operable for performing a frequency tuning process upon the television signal so as to generate an intermediate television signal; an S-video receiver 32 operable for generating an intermediate S-video signal from the S-video signal; and a demodulator 33 operable for performing a demodulation process upon a selected one of the television signal and the S-video signal so as to generate an input audio signal and an input video signal.

In the preferred embodiment, the audio processor 34 is operable for generating the first output audio signal from the input audio signal when the first decoded audio signal is not received thereby, and from the first decoded audio signal and the input audio signal when the first decoded audio signal and the input audio signal are received thereby. When the first decoded audio signal and the input audio signal are received by the audio processor 34, the audio processor 34 is preferably configured to generate the first output audio signal such that audible reproduction corresponding to the first decoded audio signal by the second audible reproduction module 62 is louder than that corresponding to the input audio signal by the same. In other embodiments, when the first decoded audio signal and the input audio signal are received by the audio processor 34, the audio processor 34 may be configured to generate the first output audio signal solely from the first decoded audio signal, i.e., the input audio signal is not audibly reproduced by the second audio reproduction module 62.

The video processor 35 is configured to cooperate with the second display driver 36 for generating the first output video signal from the input video signal when the first decoded video signal is not received thereby, and from at least the first decoded video signal when the first decoded video signal and the input video signal are received thereby. If the video processor 35 and the second display, driver 36 are configured to generate the first output video signal from the first decoded video signal and the input video signal, the first decoded video signal and the input video signal are preferably displayed in different regions of a display area of the second display module 64, respectively, such as in a picture-in-picture manner or in a side-by-side manner. In other embodiments, when the first decoded video signal and the input video signal are received by the video processor 35, the video processor 35 and the second display driver 36 may be configured to generate the first output video signal solely from the first decoded video signal, i.e., the input video signal is not visually rendered through the second display module 64.

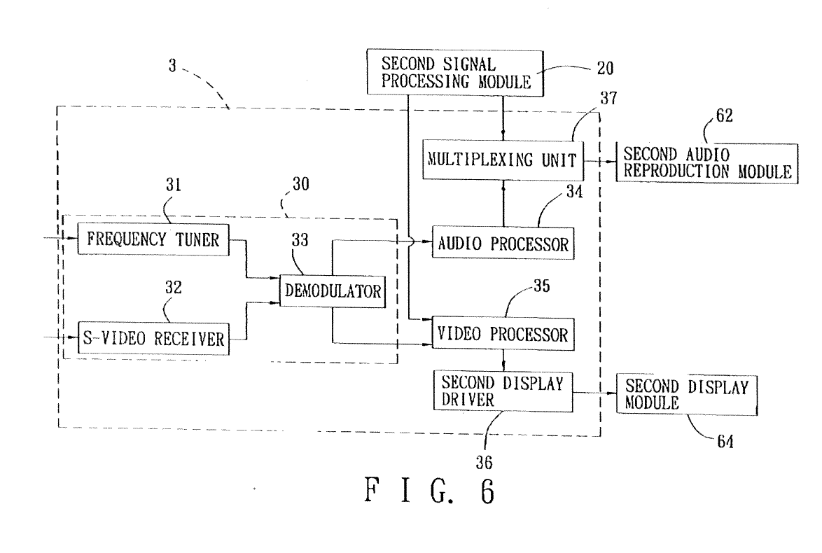

Referring to FIG. 6, in a modification, the core module 3 further includes a multiplexing unit 37 operable for generating the first output audio signal from the input audio signal when the first decoded audio signal is not received thereby, and from at least the first decoded audio signal when the first decoded audio signal and the input audio signal are received thereby.

Referring again to FIG. 3, the multimedia device 200 of the preferred embodiment further includes: a second sound-pickup module 61 (e.g., a microphone module) operable for picking up second audio information (e.g., voices of the people inside the residence) so as to generate a second to-be-encoded audio signal; and a second video-capture module 63 operable for capturing second video information (e.g., images of the people inside the residence) so as to generate a second to-be-encoded video signal.

The second signal processing module 20 further includes a second video processing unit 22 and a second encoding unit 27. The second audio processing unit 21 is further operable for processing the second to-be-encoded audio signal so as to generate a second intermediate encoded audio signal. The second video processing unit 22 is operable for processing the second to-be-encoded video signal so as to generate a second intermediate encoded video signal. The second encoding unit 27 is operable for performing preferably an MPEG encoding process upon the second intermediate encoded audio signal and the second intermediate encoded video signal so as to generate a second to-be-transmitted signal.

The second communication unit 241 is further operable for performing such as a modulation process upon the second to-be-transmitted signal so as to generate a second modulated signal, and/or transmitting the second modulated signal to the intercom device 100 via said one of the second wired communication unit 242 and the second wireless communication unit 243.

Referring again to FIG. 2, upon receipt of the second modulated signal via said one of the first wired communication unit 142 and the first wireless communication unit 143, the first communication unit 141 is further operable for performing such as a demodulation process upon the second modulated signal so as to generate a second to-be-decoded signal.

The first signal processing module 10 further includes a first decoding unit 17 operable for performing preferably an MPEG decoding process upon the second to-be-decoded signal so as to generate a second intermediate decoded audio signal and a second intermediate decoded video signal. The first audio processing unit 11 and the first video processing unit 12 are further operable for processing the second intermediate decoded audio signal and the second intermediate decoded video signal so as to generate a second decoded audio signal and a second decoded video signal, respectively.

The intercom device 100 further includes: a first audio reproduction module 52 operable for audible reproduction of the second decoded audio signal; a first display module 54; and a first display driver 16 configured to cooperate with the first video processing unit 12 so as to enable display of the second decoded video signal on the first display module 54.

Of course, the multimedia communication system of the preferred embodiment may be modified or configured such that the visitors may not see images of the people inside the residence to protect their privacy.

Moreover, each of the first and second sound-pickup modules 51, 61 preferably includes an array of sound-pickup units, and a weighting unit for weighting sound information picked up by each of the sound-pickup units and for generating a corresponding one of the first and second to-be-encoded audio signals, accordingly, thereby achieving a better Signal-to-Noise performance.

In other embodiments, the multimedia device 200 may be implemented as a portable device (e.g., a mobile internet device or a smart phone device) or a non-portable device (e.g., a video phone device).

In summary, the multimedia communication system of the preferred embodiment enables the residents to communicate with the visitors while enjoying multimedia contents.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A multimedia communication system adapted to receive an external input signal that contains external audio information, comprising:
an intercom device including
a first sound-pickup module operable for picking up first audio information so as to generate a first to-be-encoded audio signal,
a first signal processing module operable for performing an encoding process upon the first to-be-encoded audio signal so as to generate a first to-be-transmitted signal, and
a first communication module operable for performing a modulation process upon the first to-be-transmitted signal so as to generate a first modulated signal; and
a multimedia device including
a second communication module coupled to said first communication module for receiving the first modulated signal therefrom, and operable for performing a demodulation process upon the first modulated signal so as to generate a first to-be-decoded signal,
a second signal processing module operable for performing a decoding process upon the first to-be-decoded signal so as to generate a first decoded audio signal,
a core module adapted to receive the external input signal, and operable generate a first output audio signal from at least one of the first decoded audio signal and the external audio information contained in the external input signal, and
a second audio reproduction module operable for audible reproduction of the first output audio signal;
wherein:
said core module is operable for generating the first output audio signal from the external audio information contained in the external input signal when the first decoded audio signal is not received thereby; and
said core module is operable for generating the first output audio signal from at least the first decoded audio signal when the first decoded audio signal and the external input signal are received thereby.

2. The multimedia communication system as claimed in claim 1, wherein:
said multimedia device further includes a second sound-pickup module operable for picking up second audio information so as to generate a second to-be-encoded audio signal, said second signal processing module being further operable for performing an encoding process upon the second to-be-encoded audio signal so as to generate a second to-be-transmitted signal, said second communication module being further operable for performing a modulation process upon the second to-be-transmitted signal so as to generate a second modulated signal;
said first communication module is further operable for receiving the second modulated signal from said second communication module and for performing a demodulation process upon the second modulated signal so as to generate a second to-be-decoded signal, said first signal processing module being further operable performing a decoding process upon the second to-be-decoded signal so as to generate a second decoded audio signal; and
said intercom device further includes a first audio reproduction module for audible reproduction of the second decoded audio signal.

3. The multimedia communication system as claimed in claim 1, the external input signal further containing external video information, wherein:
said intercom device further includes a video-capture module operable for capturing video information so as to generate a to-be-encoded video signal, said first signal processing module being operable for performing the encoding process upon the first to-be-encoded audio signal and the to-be-encoded video signal so as to generate the first to-be-transmitted signal;
said second signal processing module is operable for performing the decoding process upon the first to-be-decoded signal so as to generate the first decoded audio signal and a decoded video signal, said core module being further operable to gene rate an output video signal from at least one of the decoded video signal and the external video information contained in the extern input signal;
said multimedia device further includes a display module operable for display of the output video signal;
said core module is operable for generating the output video signal from the external video information contained in the external input signal when the decoded video signal is not received thereby; and
said core module is operable for generating the output video signal from at least the decoded video signal when the decoded video signal and the external input signal are received thereby.

4. The multimedia communication system as claimed in claim 1, wherein communications between said intercom device and said multimedia device is based upon one of Session Initiating Protocol (SIP), transmission control protocol internet protocol (TCP/IP) suite, and worldwide interoperability for microwave access (WIMAX).

5. The multimedia communication system as claimed in claim 1, wherein said multimedia device is one of a television device, a mobile internet device, a smart phone device, and a video phone device.

6. A television device adapted to receive a first modulated signal that contains first audio information picked up by an intercom device, and an external input signal that contains external audio information, said television device comprising:
a communication module adapted for receiving the first modulated signal, and operable for performing a demodulation process upon the first modulated signal so as to generate a to-be-decoded signal;
a signal processing module operable for performing a decoding process upon the to-be-decoded signal so as to generate a decoded audio signal;
a core module adapted to receive the external input signal, and operable to generate an output audio signal from at least one of the decoded audio signal and the external audio information contained in the external input signal; and
an audio reproduction module operable for audible reproduction of the output audio signal;
wherein:
said core module is operable for generating the output audio signal from the external audio information contained in the external input signal when the decoded audio signal is not received hereby; and
said core module is operable for generating the output audio signal from at least the decoded audio signal when the decoded audio signal and the external input signal are received thereby.

7. The television device as claimed in claim 6, further comprising a sound-pickup module operable for picking up second audio information so as to generate a to-be-encoded audio signal, wherein said signal processing module is further operable for performing an encoding process upon the to-be-encoded audio signal so as to generate a to-be-transmitted signal, said communication module being further operable for performing a modulation process upon the to-be-transmitted signal so as to generate a second modulated signal for receipt by the intercom device.

8. The television device as claimed in claim 6, the first modulated signal further containing first video information captured by the intercom device, the external input signal further containing external video information, wherein:
said signal processing module is operable for performing the decoding process upon the to-be-decoded signal so as to generate the decoded audio signal and a decoded video signal, said core module being further operable to generate an output video signal from at least one of the decoded video signal and the external video information contained in the external input signal;
said television device further comprising a display module operable for display of the output video signal;
said core module being operable for generating the output video signal from the external video information contained in the external input signal when the decoded video signal is not received thereby; and
said core module being operable for generating the output video signal from at least the decoded video signal when the decoded video signal and the external input signal are received thereby.

9. The television device as claimed in claim 6, further comprising a video-capture module operable for capturing second video information so as to generate a to-be-encoded video signal, wherein said signal processing module is further operable to perform an encoding process upon the to-be-encoded video signal so as to generate a to-be-transmitted signal, said communication module being further operable to perform a modulation process upon the to-be-transmitted signal so as to generate a second modulated signal for receipt by the intercom device.

10. A core module for a television device, adapted to receive a decoded audio signal and an external input signal containing external audio information, and operable for generating an output audio signal from at least one of the decoded audio signal and the audio information contained in the external input signal for sound reproduction, said core module comprising:
a tuning unit adapted to receive the external input signal, and operable for performing a frequency tuning process upon the external input signal so as to generate an input audio signal; and
an audio processing unit operable for generating the output audio signal from the input audio signal when the decoded audio signal is not received by said core module, and from at least the decoded audio signal when the decoded audio signal and the external input signal are received by said core module.

11. The core module as claimed in claim 10, wherein said audio processing unit is operable for generating the output audio signal from both the decoded audio signal and the input signal when the decoded audio signal and the external input signal are received by said core module.

12. The core module as claimed in claim 10, the external input signal further containing external video information, said core module further comprising a video processing unit, being further adapted to receive a decoded video signal, and being further operable for generating an output video signal from at least one of the decoded video signal and the video information contained in the external input signal for visual rendering, wherein:
said tuning unit is operable for performing the frequency tuning process upon the external input signal so as to generate the input audio signal and an input video signal; and
said video processing unit is operable for generating the output video signal from the input video signal when the decoded video signal is not received by said core module, and from at least the decoded video signal when the decoded video signal and the external input signal are received by said core module.

13. The core module as claimed in claim 12, wherein said video processing unit is operable for generating the output video signal from both the decoded video signal and the input videos signal when the decoded video signal and the external input signal are received by said core module.
